(19) United States
(12) Patent Application Publication
(10) Pub. No.: US 2009/0017660 A1
(43) Pub. Date: Jan. 15, 2009

(54) Water Resistant Push-In Connector

(76) Inventors: Austin R. Braganza, Milwaukee, WI (US); Patrick J. Radle, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 12/171,072

(22) Filed: Jul. 10, 2008

Related U.S. Application Data
(60) Provisional application No. 60/959,049, filed on Jul. 11, 2007.

(51) Int. Cl. H01R 13/52

(52) U.S. Cl. 439/276

(57) ABSTRACT

A water resistant push-in wire connector provides an electrical connection for two or more wires spliced together in a wet or underground location. The connector includes a non-conductive housing having a cavity filled with a water insoluble, non-conductive substance and a self-engaging contact clamp. The substance is sufficiently viscous such that it does not flow out of a series of wire entry holes extending through the housing and into the cavity, and the wires help seal the substance from flowing out of the connector.

### CROSS-REFERENCE TO RELATED APPLICATION

This application claims the benefit of U.S. provisional patent application 60/959,049 filed Jul. 11, 2007, which is hereby incorporated by reference in its entirety.

### STATEMENT REGARDING FEDERALLY SPONSORED RESEARCH OR DEVELOPMENT

Not applicable.

### FIELD OF THE INVENTION

This invention generally relates to electrical conductor, or wire, connectors and more particularly to a water resistant push-in wire connector suitable for use in wet environments.

### BACKGROUND OF THE INVENTION

Wire connectors are commonly used to quickly and securely splice two or more wires together. One type of electrical connector is known as a twist-on wire connector. Twist-on wire connectors have a non-conductive housing such as plastic or ceramic and a tapered, conducting metal coil insert. Two or more wires are inserted into the connector which is then twisted about the wires a number of times. Eventually, the coil becomes threaded onto the wires, thereby joining the wires together as well as securely fastening the wires within the connector. Twist-on wire connectors are also known as cone or thimble connectors.

Another type of electrical connector is known as a terminal block-type connector. In a terminal block connector, individual wires are pressed down against a metal busbar by a screw or a spring tensioned contact plate. In a terminal block connector having screw contacts, the wire is stripped of insulation at one end and either bent to fit around the shaft of the screw or simply inserted between the busbar and contact plate. The screw is tightened to securely connect the wire to the busbar within the terminal block. In a terminal block having a tensioned contact plate, one end of the wire is inserted between the busbar and contact plate which is secured within the terminal block by the spring-applied tension.

Wire connectors that provide a water resistant electrical connection are often used to comply with safety requirements for installations involving underground wire splicing and wire splicing subject to water exposure. Examples of such installations include, but are not limited to, pools, sprinkling system, fountains, utility pumps, and outdoor lighting. For safety reasons, electrical wires must be securely isolated from water to reduce electrical shocking hazards. Also, for reliability reasons, electrical wires are isolated from water to prevent any oxidation of the metal conductors. This isolation may be accomplished through the use of water resistant connectors.

One type of commercially available water resistant wire connector is a twist-on wire connector filed with a non-conductive sealant. The sealant may be a viscous sealant such as silicone or grease, held within the connector by a cover, or a two part epoxy solution that hardens after being mixed by the insertion of the wires. However, these connectors require that the spliced wires be pre-twisted before insertion into the non-conductive sealant. Further, to add or remove a wire, all of the wires must first be disassembled from the connector instead of just one or two.

Another type of commercially available water resistant wire connector includes a kit having a terminal block and, a housing, and a sealing agent (e.g., epoxy, silicone gel, air). To splice a number of wires together, the wires are first attached to the terminal block and placed within the housing. The sealing agent is added to the housing (except for connectors using air as the sealing agent) and acts to electrically isolates the wires from the surrounding environment. These connectors overcome some of the problems with water resistant twist-on wire connectors. However, if a viscous sealing agent is used and an additional wire is to be added or removed, the housing must be opened to access the terminal block inside. The subsequent seal may not be as water resistant as the initial seal. Further, the terminal block is covered with sealant making it and/or the wires difficult to handle. If a hardening sealing agent is used and a wire needs to be added or removed, all of the wires must be cut and a new kit used to comply with applicable safety requirements.

Hence, a need exists for an improved means for joining multiple wires together that provides both a water resistant electrical connection and the ability to easily add or remove one or more wires without having to disassemble or destroy an existing water resistant connection.

### SUMMARY OF THE INVENTION

One aspect of the present invention provides a water resistant push-in electrical connector. The connector includes a housing defining an internal cavity and at least two wire guides extending between a front surface of the housing and the cavity. The cavity is completely enclosed except for the openings of the two wire guides. The connector further includes a self engaging contact clamp retained within the cavity. The contact clamp is positioned and oriented within the cavity so as to engage any wires inserted into the cavity through the wire guides. The contact clamp is formed of a conductive material to provide an electrical connection between wires inserted into the connector. The contact clamp exerts a force on the wires such that the wires resist being pulled out of engagement with the contact clamp. The connector further includes a water resistant, non-conductive, material inside the cavity that encases the contact clamp. The material is able to be pierced by the wires inserted into the connector so as to encapsulate wires engaged by the contact clamp.

A further aspect of the present invention is a method of making a water resistant push-in electrical connector by inserting a water insoluble, non-conductive substance into a housing having a self-engaging electrically conductive clamp therein. A still further aspect is a method of providing a water resistant connection between two or more electrical wires without the use of screw terminals or twist-on wire connectors by inserting at least two electrical wires into a self-engaging electrically conductive clamp that is encapsulated in a water insoluble, non-conductive substance.

These and still other advantages of the invention will be apparent from the detailed description and drawings. What follows is merely a description of a preferred embodiment of the present invention. To assess the full scope of the invention the claims should be looked to as the preferred embodiment is not intended to be the only embodiment within the scope of the claims.

### BRIEF DESCRIPTION OF THE DRAWINGS

FIG. 1 is an isometric view of a water resistant push-in wire connector constructed in accordance with one aspect of the present invention with the housing illustrated in outline only for ease of illustration;

FIG. 2 is a cross-sectional view of the push-in wire connector taken along line 2-2 of FIG. 1;

FIG. 3 is a cross-sectional view of the connector of FIG. 2 with a wire secured therein;

FIG. 4 is an exploded isometric view of the push-in wire connector of FIG. 1; and

FIG. 5 is a fragmentary cross-sectional view of a portion of the push-in wire connector taken along line 5-5 of FIG. 2.

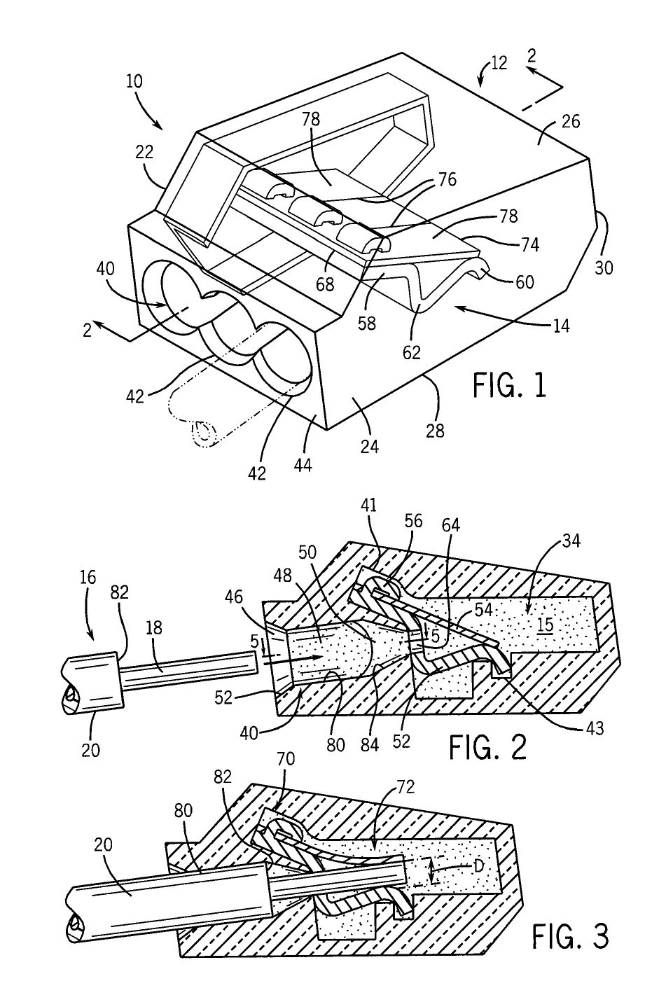

### DETAILED DESCRIPTION OF THE PREFERRED EMBODIMENT

Referring to the figures, one embodiment of a water resistant push-in wire connector 10 includes a housing 12, a multi-wire contact clamp 14, and a water resistant dielectric, i.e., non-conductive, substance 15. The illustrated connector 10 is able to splice together two or three wires 16. The typical wire 16 includes a solid electrical conductor 18, typically copper, surrounded by a layer of insulation 20.

The housing 12 is a generally six sided enclosure including first and second side walls 22, 24, a top wall 26, a bottom wall 28, a rear wall 30, and a front wall 32 together defining an internal cavity 34. The first side wall 22 includes a large opening 36 formed therein to provide access to the cavity 34 and the contents therein. A cover 38 can be press fit into the opening 36 and retained therein such that the housing 12 is totally enclosed except for a number of wire guides 40. Upper and lower clamp retention channels 41, 43 are formed in the housing 12 to properly position and orientate the contact clamp 14 within the cavity 34.

The wire guides 40 extend between openings 42 in a front surface 44 of the connector 10 and the cavity 34. The illustrated connector 10 includes three partially overlapping wires guides 40; however, it is contemplated that the connector 10 may be formed with more or less guides 40 as desired. The wire guides 40 are sized so as to correspond to the gauge of the wires 16 spliced together by the connector 10. The guides 40 may all have the same diameter, as illustrated, or, alternatively, may have differing diameters for splicing different gauged wires.

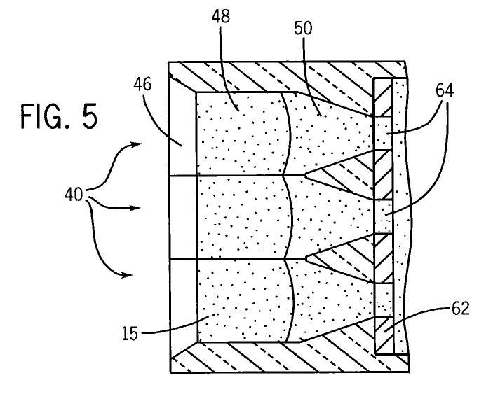

As best illustrated in FIG. 2, each wire guide 40 includes an outer conical guide 46, a cylindrical saddle 48, and an inner conical guide 50. The outer guide 46 is defined by an angled wall 52 that tapers radially inwardly from the opening 42 in the front surface 44 to the saddle 48. The saddle 48 has a uniform diameter and is sized to accommodate a variety of wire gauges. The inner guide 50 tapers radially inwardly from the saddle 48 to the cavity 34. It should appreciated that although the wire guides 40 are described and illustrated as being partly cylindrical and partly conical or tapered, alternate configurations, such as a bore/counter bore arrangement, are contemplated. Furthermore, as shown best in FIG. 5, the wire guides 40 have an overlapping portion and non-overlapping portion, though other configurations are contemplated.

Referring specifically to FIG. 4, the contact clamp 14 is shown removed from the housing 12. The contact clamp 14 is formed from two pieces: a generally S-shaped busbar 52 and a rectangular contact plate 54 secured to the busbar 52 by a series of hooks 56. The busbar 52 is formed from a single piece of electrically conductive metal, for example, steel, brass, copper, aluminum alloy, etc., through a stamping and bending process. The busbar 52 has an angled upper leg 58, a tapered lower leg 60 and a curved middle section 62 extending therebetween. The contact plate 54 is formed of a conductive, springy, and stiff material, such as spring steel.

As best shown in FIG. 2, the middle section 62 of the busbar 52 includes an aperture 64 to permit entry of the bare conductor 18 into the cavity 34. When the clamp 14 is properly oriented and positioned within the housing 12, the apertures 64 are axially aligned with the wire guides 40. Each aperture 64 accommodates one bare conductor 50.

The contact plate 54 is electrically connected and mechanically secured to the upper leg 58 of the busbar 52 by a series of equidistantly spaced hooks 56 and slots 66. To assemble the contact clamp 14, the contact plate 54 is placed onto the busbar 52 while the hooks 56 are unbent or slightly bent (pre-bent hooks 56 are able to pass through a series of matching slots 66 formed in a first end 68 of the contact plate 54). When the contact plate 54 is flush against the upper leg 58 of the busbar 52, the hooks 56 are bent over and pressed firmly against the plate 62. The fully assembled contact clamp 14 includes a hinged end 70 formed where the contact plate 54 is pressed against the upper busbar leg 64 and a contact end 72 formed where a second end 74 of the contact plate 54 contacts the tapered leg 60 of the busbar 52.

The contact plate 54 further includes a series of equidistantly spaced longitudinal slits 76 extending inwardly from the second end 74. The slits 76 define a number of individual contact arms 78, Each contact arm 78 is centered with respect to a respective wire guide 40 such that a conductor 18 inserted into the cavity 34 through one guide 40 will only come into contact with the contact arm 78 axially aligned with the guide 40.

In one embodiment, the connector 10 is constructed by first removing the cover 38 and contact clamp 14 from the housing 12. The cavity 34 is then packed with a water insoluble, non-conductive substance 15. Suitable, commercially available substances include a dielectric grease produced by Loctite, Inc. (p/n 30536) and a synthetic grease having good dielectric properties produced by Viper Lube, Inc (p/n 36781). After filling the cavity 34 with a suitable amount of non-conductive grease 15, the contact clamp 14 is reinserted into the housing 12 through the opening 30. The clamp 14 ultimately becomes completely encapsulated by the dielectric grease. The cover 38 is press fit back into the opening 30 to secure the contact clamp 14 and sealant within the cavity 34.

Although the wire guides 40 provide an opening between the cavity and the surrounding environment, the non-conductive grease 15, because of its viscous, non-flowing nature, substantially remains within the cavity 34. However, as shown in FIGS. 2, 3 and 5, an amount of the grease 15 is present in the wire guides 40 to encapsulate any bare conductor 18 situated therein. Alternatively, other substances, such as a potting compound that sets after exposure to air or a self-healing polymer insulation, may be used to encapsulate the contact clamp 14 and bare conductors 18.

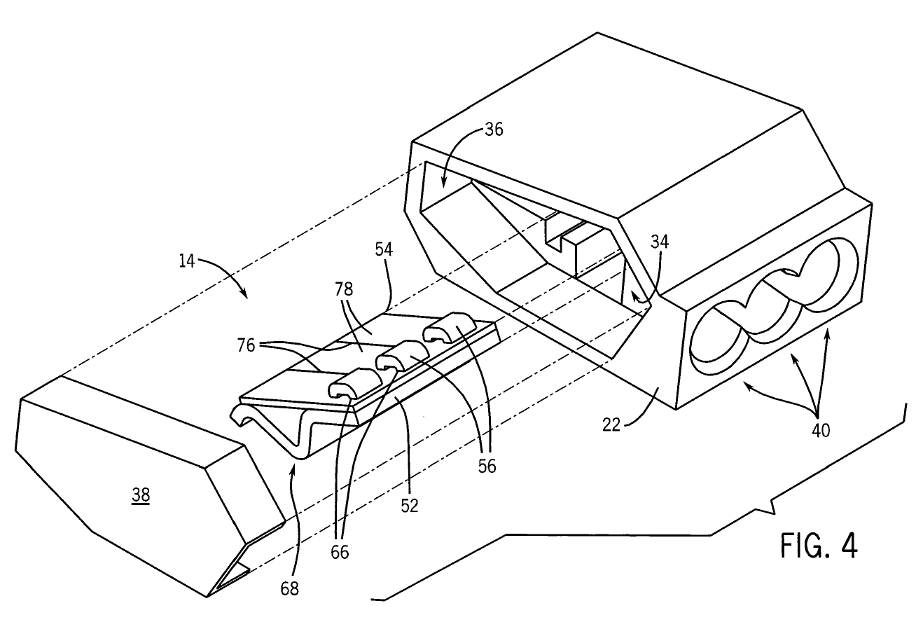

In use, the push-in connector 10 provides a water resistant electrical splice for at least two wires 16. The resulting splice complies with certain electrical safety standards covering direct bury splices. A first wire 16 having an electrical conductor 18 stripped of insulation 20 is inserted through a wire guide opening 42 located on the front surface 44. As the conductor 16 is urged into the wire guide 40 and towards the cavity 34, the first and second guides 46, 50 direct the wire 16 accordingly. An inner surface 80 of the saddle 48 may frictionally engage the insulation 20 as shown in FIG. 3. Even if the insulation 20 is not frictionally engaged by the inner surface 80, the saddle 48 is substantially filled by the unstripped wire 16.

The bare conductor 18 is further urged through the aperture 64 in the busbar 52 and into the cavity 34. The conductor 18 pierces, or displaces, the water insoluble non-conductive substance 15 contained therein and presses against one contact arm 78. The contact arm 78 is deflected radially outward by a distance D. Because of the cantilevered connection and springy characteristics of the contact plate 54, a bending stress is placed on the contact arm 78 when displaced from a normally resting position (FIG. 2). The bending stress causes the contact arm 78 to firmly press the conductor 18 into direct contact with the lower leg 60 of the busbar 52.

When the wire 16 is fully inserted into the connector 10, a front edge 82 of the insulation 20 presses against the surface 84 of the inner conical guide section 50. The force exerted on the conductor 18 by the deflected contact arm 78 engages the conductor 18 so as to hinder the wire 16 from being pulled out of the connector 10. Additional wires 16 are then inserted into the other wire guides 40 of the connector 10 in the same manner and subsequently become spliced together. Although limited by the size of the wire guide 16, the connector 10 may accommodate wires of different gauges because each contact arm 78 is able to flex independently from the adjacent contact arms 78.

Once all of the wires 16 have been fully inserted, the viscous sealant encapsulates the contact clamp 14 and the entirety of each of the bare conductors 18. The edge 82 of the insulation 20 abuts the tapered surface 84 of the inner guide section 50 so as to provide a seal between the non-conductive grease 15 within the cavity 34 and the surrounding environment. Even without the seal, however, the non-conductive grease 15 substantially remains within the housing 12, thus providing a water resistant push-in electrical connection for multiple wires. The electrical connection is provided by the self-engaging conductive contact clamp 14 that secures the bare conductors 50 within the cavity 34. The water insoluble, non-conductive substance 15 is contained within the housing 12 and electrically isolates and protects the contact clamp 14 and each of the bare conductors 18 secured therein from moisture in the surrounding environment.

Preferred embodiments of the invention have been described in considerable detail. Many modifications and variations to the preferred embodiments described will be apparent to a person of ordinary skill in the art. Therefore, the invention should not be limited to the embodiments described.

We claim:

1. A water resistant push-in wire connector comprising:
a housing, said housing defining a cavity and at least two wire guides extending between an outer surface of the housing and the cavity, the cavity being enclosed except for said at least two wire guides;
a self-engaging clamp, said clamp being positioned within the cavity so as to engage each of at least two conductors inserted through respective wire guides, said clamp being conductive so as to provide an electrical connection between the conductors, said clamp exerting a force on the conductors that resists the conductors being pulled out of engagement with the clamp; and
a water insoluble material disposed inside of the cavity; said material encasing the clamp and being piercable by the conductors so as to encapsulate the clamp and conductors engaged by the clamp.

2. The connector of claim 1 wherein the clamp comprises:
a busbar including at least two apertures axially aligned with the at least two wire guides and through each of which a respective conductor is inserted; and
a contact plate;
wherein the contact plate includes a first end electromechanically connected to the busbar and a second end that applies a force against the at least two conductors upon contact therewith.

3. The connector of claim 2, wherein the contact plate includes at least two latitudinal slots spaced apart at the first end and at least one longitudinal slit extending from the second end defining at least two contact arms

4. The connector of claim 2, wherein the busbar further includes flat angled leg, a tapered leg, and an bent portion extending therebetween; wherein the housing further includes first and second side walls and first and second channels extending at least partially between said first and second side walls; wherein at least a portion of the angled leg is received within the first channel and at least a portion of the tapered leg is received within the second channel so as to position and orientate the clamp within the housing.

5. The connector of claim 1, wherein the first side wall includes an opening formed therein and a cover press fit into the opening; wherein the clamp is inserted into the housing through the opening and fixedly secured within the housing after the cover is placed within the opening.

6. The connector of claim 5, wherein the water insoluble material is inserted into the housing via the opening in the first wall.

7. The connector of claim 1, wherein the water insoluble material is viscous and non-hardening.

8. The connector of claim 7, wherein the water insoluble substance is one of a dielectric grease and a synthetic grease with dielectric properties.

9. The connector of claim 1, wherein a diameter of each of the at least two wire guides tapers inwardly extending between the outer surface and the cavity.

10. The connector of claim 1, wherein each of the at least two wire guides has an conical section and a cylindrical section.

11. The connector of claim 10, wherein the conical section of each of the at least two wire guides is plugged by an unstripped portion of the respective conductor inserted therein.

12. The connector of claim 1 comprising an equal number of wire guides and contact arms such that upon fully inserting a conductor into the cavity, only the contact arm axially aligned with the wire guide is displaced and pressing the conductor into an electrical connection with the busbar.

13. A method of making a water resistant push-in electrical connector comprising:
inserting a water insoluble, non-conductive substance into a housing having a self-engaging electrically conductive clamp therein.

14. The method of claim 13, further comprising:
removing the self-engaging electrically conductive clamp from the housing prior to inserting the substance into the housing; and
reinserting the clamp into the housing after inserting the substance such that the clamp is completely encapsulated by the substance.

15. The method of claim 14, wherein the sealant is a dielectric grease.

16. The method of claim 14, wherein the sealant is a synthetic grease having dielectric properties.

17. The method of claim 14, wherein each wire guide has a conical section that is plugged by an unstripped portion of a respective conductor inserted therein.

18. A method of providing a water resistant connection between two or more electrical wires without the use of screw terminals or twist-on wire connectors, the method comprising:
inserting at least two electrical conductors into a self-engaging electrically conductive clamp encapsulated in a water insoluble, non-conductive substance.

19. The method of claim 18, wherein the clamp is arranged inside of a housing.

20. The method of claim 19, wherein the water insoluble, non-conductive substance is a dielectric grease.
